(19) United States
(12) Patent Application Publication
(10) Pub. No.: US 2017/0335549 A1
(43) Pub. Date: Nov. 23, 2017

(54) Design and Process to Collect Urban Storm Drainage for Commercial and Residential Use

(71) Applicant: Gregory M Majersky, Denver, CO (US)

(72) Inventor: Gregory Michael Majersky, Denver, CO (US)

(73) Assignee: Gregory M Majersky, Denver, CO (US)

(21) Appl. No.: 15/157,386

(22) Filed: May 17, 2016

(51) Int. Cl. E03B 3/02; E01C 11/24; B65G 5/00

(52) U.S. Cl. CPC E03B 3/02; B65G 5/00; E01C 11/24

(57) ABSTRACT

A process and method of collecting, storing and utilizing the water that enters urban storm drainage systems for the purpose of utilization and reuse. Step 1 is the existing urban storm water system in an urban area. Step 2 in this process and method that store the urban storm water also serve to provide initial levels of treatment. At Step 3 is where water is diverted based on commercial versus residential water needs. Step 4.a is where water enters commercial facilities and is treated according to each commercial consumer's needs. Step 4.b is where both treated commercial waste water and water from Step 2 can be stored in subsurface geology, where some water quality treatment will occur. At Step 4, commercial facilities may also extract water for reuse. Treatment for human consumption at Step 5 would be decided by relevant government laws and regulations. This process and method has been designed to collect, store and allow for the utilization of urban storm water for the purpose of keeping polluted urban storm water out of naturally occurring bodies of water, reduce or eliminate the extraction of water from natural sources, which helps restore and maintain a healthy ecosystem. Example calculations show that in Mumbai, India, the average yearly amount of water that enters the urban storm system is greater than the combined annual average of potable and industrial needs for the city of Mumbai. In other cities, average annual precipitation that enters the urban storm drainage system of many cities provides at least half of the combined annual average of potable and industrial water needs.

### BACKGROUND OF THE INVENTION

I. Throughout history, urban storm drainage has been collected by the following methods:
1. Simple roof water collection: Rain that falls on roof tops is collected into rain barrels or cisterns under the buildings.
2. Large scale roof top and grounds collection: Large buildings such as warehouses and factories, and their surrounding grounds, can be re-engineered to collect rain water for non-potable uses.
3. High rise building rooftop collection: The roofs of high rise buildings can be stored for non-potable use.
4. Designed urban catchment basins: Specifically designed catchment basins, only used for collecting rain water, can be placed around an urban area and store water for agricultural use.

II. These methods have the following weaknesses:
1. The volume of water collected is very limited due to the small surface areas.
2. The water has very limited use due to the small volume and water quality.
3. Rain water that falls on streets, sidewalks and other urban surfaces still enters natural waters with all of the contaminants present on those surfaces.
4. Extra cost and resources are required to design catchment abilities for structures or re-design existing structures to have rain water catchment and storage abilities.

III. My method possesses the following strengths in comparison to the previously discussed methods in
1. My method utilizes existing urban environments and urban storm drainage networks.
2. Using the entire urban area, the volume of water captured is much greater than any of the methods in (I), see Examples for calculations.
3. With modern water treatment technology, my method can provide water for any commercial or residential use.
4. My method allows each commercial user to treat the water they buy to their own specifications with appropriate technology.
5. My method provides a water source for potable water for residential use.
6. My method prevents polluted urban storm drainage from entering the environment, unlike the methods in (I).
7. My method costs far less than excavating rain water catch basins to obtain the same volume of water, see Examples for calculations.
8. My method is the first of its kind and there is no published prior art like it in the world.

### OBJECTIVES OF THE INVENTION

Accordingly, it is an objective of this invention to provide an additional source of water and protect the environment.

Another objective is to provide a significantly more cost effective solution to collect rain, snow and surface water.

Another objective is to provide a design that allows storm water drainage to be directed where it is needed most at any particular time, to commercial or residential users.

A further objective is to provide an alternative to small scale rooftop rain water harvesting techniques.

A still further objective is to limit or prevent urban storm water from carrying pollutants from urban areas into natural bodies of water.

Another objective is to provide Commercial facilities to purchase urban storm drainage water for far less cost than from a municipal treatment facility. Each commercial facility is at liberty to treat their purchased urban storm drainage water to their specific standards.

Still another objective is to allow natural sources of water, both at the surface and below the surface, to recover in the absence of pollution and due to having less or no water extracted for residential and commercial purposes.

Another objective is to allow many urban areas around the world to achieve near or total water self-sufficiency.

Other objectives and advantages of the invention will be apparent from the specification and claims, and the scope of this invention will be set forth in the claims.

### DESCRIPTION OF THE DRAWING

FIG. 1 is a schematic view of the invention.

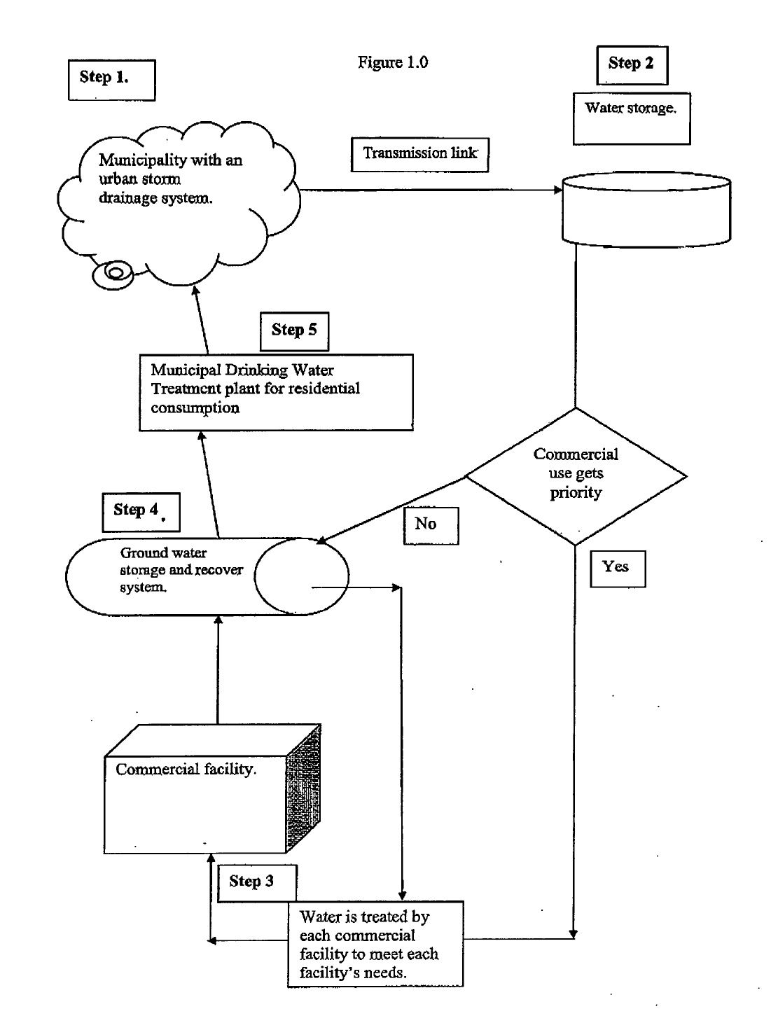

### DESCRIPTION OF THE INVENTION

The drawing shows Step 1, the Municipality, equipped with a urban storm drainage system to collect rain, snow and surface flow (ex: floods). The discharge points of the urban storm drainage system are connected to a transmission system, (which could be a pipe, canal, culvert, ditch or tunnel). At Step 2, the water from the urban storm drainage system is collected and stored.

At Step 3, local stakeholders can decide where the needs for the stored water lie. If the priority is commercial usage, the transmission system can carry the water to commercial facilities, which is Step 4.a in the process. For all around cost effectiveness, the water would not be treated until it reaches each commercial entity. Each commercial entity is then free to treat the water it receives to its own specifications. This is important as not all commercial water needs are the same. Not every entity needs potable water, nor do some commercial operations want water containing disinfectants such as chlorine.

If local stakeholders decide that residential needs take priority, the transmission system can divert all or some of the water away from commercial entities and into an underground storage facility in Step 4.b. The transmission system will then transport the water to a licensed municipal water/public treatment works as shown in Step 5. This potable water is then distributed to residential users in the same municipality where the urban storm drainage system captured the water. Some of this potable water can also be distributed to users outside of the municipality. Excess water not used for commercial or potable use could be distributed to farmers, etc at Step 2.

Examples of potential rain, snow and surface water capture:

### Example 1

These calculations and assumptions are based on data publicly available in the US and are not meant to replace or supplant local obtained data in Polokwane, Republic of South Africa (RSA).

It is assumed that within the Polokwane metropolitan area, piping costs would be negligible compared to storage, treatment and ground water injection costs.

Labor costs are integrated into these calculations, but based on Canada/United Kingdom labor costs, not RSA labor costs.

I did not factor in potential cost reductions due to assistance from international development programs.

### LIST OF ASSUMED SIGNIFICANT COSTS

Water storage in Stage 2—storage tanks.

It is not possible to assume the cost of water treatment for each commercial consumer in Polokwane without knowing each commercial entity's specific water quality requirements.
Beverage makers, pharmaceuticals and computer equipment requires very clean water, other industries do not.

Molson Coors has 2 breweries and two in Canada, their groundwater sources will be depleted in 5-10 years and they need a new source of water.

In 2014:

In the UK and Canada, Molson Coors consumed 21,762,000,000,000 liters (768,517,777,193.035 cubic feet) of water per year.

South Africa consumes 972,000,000,000 liters per year; Limpopo consumes 101,349,000,000 liters per year. Polokwane receives 52,000,000,000 liters of rain per year

Molson Coors wanted to capture rain water to help meet these needs as their aquifer sources will run dry in 5-10 years. Their original plan was to install catchment-storage basins to supply water to the breweries.

The average cost, between the UK and Canada, to construct a retention basin is $4.72 USD/cu. Ft. (2011).

The total cost to build retention basins to capture and store water for Molson Coors' yearly needs would be ˜768517777193.035 cubic feet*$4.72 cu. Ft=$3,627,403,908,351 USD

Molson Coors 2014 est. market cap is $1.0.861 Billion USD

Using urban storm drainage and adjusting costs for Limpopo's water consumption
1. Assuming Polokwane's entire surface area is paved and serviced with a unified urban storm drain system, Polokwane receives 52,000,000,000 liters of rain a year that can be captured. p1 2. Polokwane/Molson Coors 2014 water usage ratio: 52,000,000,000/21,762,000,000,000=0.0024
3. Piping costs between the breweries and adjacent urban areas are negligible.
4. Storage costs are greatly reduced, perhaps only 3 months (25% or 0.25 of 1 year) of storage (in tanks) using other water practices (process water reuse, toilet to tap, etc). Now storage costs are;
   a. $3,627,403,908,351 USD *0.25*0.0024=$2,176,442,345 USD to store 3 months of Polokwane's rain water
   b. Using concrete storage tanks, at $0.003 per liter, the cost would be $180,514,285 USD
   c. Molson Coors must use detention basins to catch the rain water as well as store it
5. Cost of ground water recharge system
   a. Orange County, CA Groundwater Replenishment System cost $481 Million USD to design and construct in 2008, in 2014 USD=$527,892,936.9, processing 3,143,005,337 cu. Ft. or 88,969,999,996 liters
   b. Ration of yearly Polokwane vs Orange county cost per volume: 52,000,000,000 liters/88,969,999,996 liters=0.568
   c. Orange County plant cost in 481 million to build, multiply by Polokwane ratio: $481,000,000*0.58=$278,980,000 USD
6. Total cost of installation, assuming that storage and groundwater recharge system are the significant capital expenditures:
   a. $180,514,285+278,980,000=$459,494,285 USD. Processing 52,000,000,000 liters of water equates to $0.009 USD per liter or $0.033 USD per gallon, using the concrete storage tanks.
7. Summary
   a. I used data from the Molson Coors project to establish their cost to develop precipitation catch basins to feed their breweries in the UK and Canada.
      i. They need to collect and store 21,762,000,000,000 liters of water per year, total, for all four breweries.
      ii. They would need to pay $3.6 trillion USD to construct basins of sufficient size to maintain current production at all Canada and UK breweries.
   b. I compared the water consumption of Molson Coors with the rainfall that Polowane receives, to create a cost ratio of 0.0024
   c. I also estimated the necessary storage capacity for Polokwane to have sufficient water during dry seasons. Only for the sake of this overview, I made this estimation making an assumption that collected storm water would be Polokwane's only source of water, but not the only water conservation method.
      i. I estimated that Polokwane would need enough storage for 3 months of water usage (25% of 1 year).
   d. Multiplying the #3.6 trillion USD cost to Molson Coors with the water ratio (0.0024) and the cost of 3 months of storage (0.25), I arrived a cost of $2.176 billion USD to collect Polokwane's water in open basins.
   e. Using concrete storage tanks instead of detention basins costs $180 million USD
   f. I compared the water usage of Orange County, CA, USA to Polokwane's annual precipitation to create a ratio, 0.58
   g. This ratio was applied to the cost of the Orange County system, to generate a cost of $279 million USD
   h. Total of significant costs to construct this system to serve all of Polokwane: $459 million USD, 0.13% of South Africa's 2014 GDP.
   i. Cost per volume is $0.009 USD/liter, or $0.033 USD/gallon
8. Other considerations:
   a. All costs are based on Canada/UK costs, including labor. RSA costs should differ significantly.
   b. Materials and knowhow for the groundwater treatment and injection system should be much cheaper now, as this was the first project of its kind in the world.
   c. The materials to construct the system (such as membranes and UV treatment systems) should be very economical in the global market.
   d. I did not factor in cost reductions due to assistance from international development programs.
   e. As global climate changes, Sub Saharan Africa, like the rest of the world, will see more intense periods of precipitation and lack of precipitation (See attached report)
   f. Limpopo state is in a region of South Africa that will receive greater amounts of precipitation, while higher elevation areas like Pretoria and Johannesburg will experience decreasing yearly precipitation.
   g. South Africa's high unemployment rate could benefit from a major public works project like this.
   h. Water not used by Polokwane or Limpopo industries could be sold to larger cities and farming regions of South Africa.

### Example 2

1. Ft McMurray, Canada annual precipitation:
2. 27 million cubic meters
3. In 2011, Suncor withdrew 143.6 mil cu. m., primarily from the Athabasca river
4. Ft. Mcmurray's precip is 20% of Suncor's needs

### Example 3

1. Mumbai, India required 1.18 E+12 liters of water in 2009
2. Mumbai received 1.31 E+12 liters of precipitation in 2009, greater than the city's entire water needs

### CLOSING STATEMENT

While the invention has been described with reference to particular embodiments, it is not intended to illustrate or describe herein all of the equivalent forms or ramifications thereof. Also, the words used are words of description rather than limitation, and various changes may be made without departing from the spirit or scope of the invention disclosed herein. It is intended that the appended claims cover all such changes as fall within the true spirit and scope of the invention.

What is claimed is:

1-9. (canceled)

10. A method for urban storm water containment, transmission, and management, comprising: an existing urban storm water collection and transmission system (Step 1) connected at discharge points to a transmission system that transports the water to a temporary storage area (Step 2).

11. A method further comprising of a transmission method that will transport water to Step 3, where water can be distributed to commercial users or residential consumers depending on local needs determined by decision makers. If water is to be transported from Step 3 to Step 4.a, the water will be treated by each commercial consumer based on their individual needs. Commercial users will transmit their waste water to Step 4.b. If the water is to be transported from Step 3 to Step 4.b, the water will be stored in subsurface geology for later use by residential or commercial consumers.

12. A transmission method will transport water from Step 4.b to Step 5 where the water will be treated by a public treatment works to meet relevant government standards for potable water, then a transmission method will transmit water from Step 5 to Step 1 to provide potable water to residential consumers.
